(19) United States
(12) Patent Application Publication
(10) Pub. No.: US 2012/0139272 A1
(43) Pub. Date: Jun. 7, 2012

(54) HANDLE OF THE TYPE HAVING A LEVER PLATE, COMPRISING AN INERTIA SYSTEM

(75) Inventors: Fiorenzo Savant, Pianezza (IT); Christian Gallas, Pianezza (IT)

(73) Assignee: VALEO S.P.A., Santena (TO) (IT)

(21) Appl. No.: 13/389,858

(22) PCT Filed: Oct. 20, 2010
(86) PCT No.: PCT/EP2010/065815

§ 371 Date: Feb. 10, 2012

(30) Foreign Application Priority Data
Oct. 26, 2009 (EP) 09425430.7

(51) Int. Cl. E05B 3/00

(52) U.S. Cl. 292/336.3

(57) ABSTRACT

The invention relates to a motor vehicle door handle having a gripping element (21) which can rotate about a pin (30) on a fixed part (10) intended to be fastened to the door and is connected to a vehicle lock, and a stop piece (44, 47) which is part of a rocker arm (40) provided with an inertial mass (43) and hinged to the fixed part so as to pivot about a pin (41) such that during violent pivoting of the rocker arm (40) the stop piece (44, 47) moves along the path of a movable component of the handle and prevents the actuation of the lock connected to the handle, characterized in that the gripping element is a gripping lever plate (20) and the inertial mass is arranged on the handle longitudinally in front of the latter and located in the central third of the length of the gripping lever plate (21), such that the inertial mass is subject to the same inertial forces as the gripping means.

The invention relates to motor-vehicle handles and more particularly to the safety systems preventing untimely opening that are fitted to such handles.

Patent EP 1 556 569 discloses a handle of the “fridge handle” type, conventionally known for its inertia to impact, fitted with an inertial mass which, under the effect of such an impact, is inserted into the path of an operating lever kinetically connected to a gripping portion of the handle.

The object of the present invention is to provide a means for stopping an unexpected movement of a handle during a side impact in the case of a handle of the lever-plate type.

This object is achieved according to the invention by virtue of a handle as claimed in claim 1.

Other features, objects and advantages of the invention will appear on reading the detailed description made with reference to the appended figures in which:

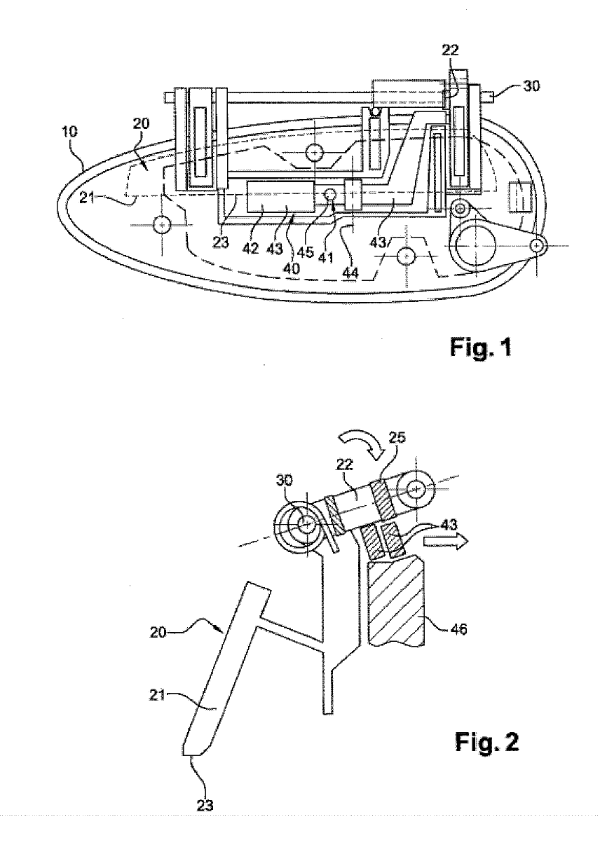

FIG. 1 is a view from behind of a handle according to a first embodiment;

FIG. 2 is a partial side view of this same handle;

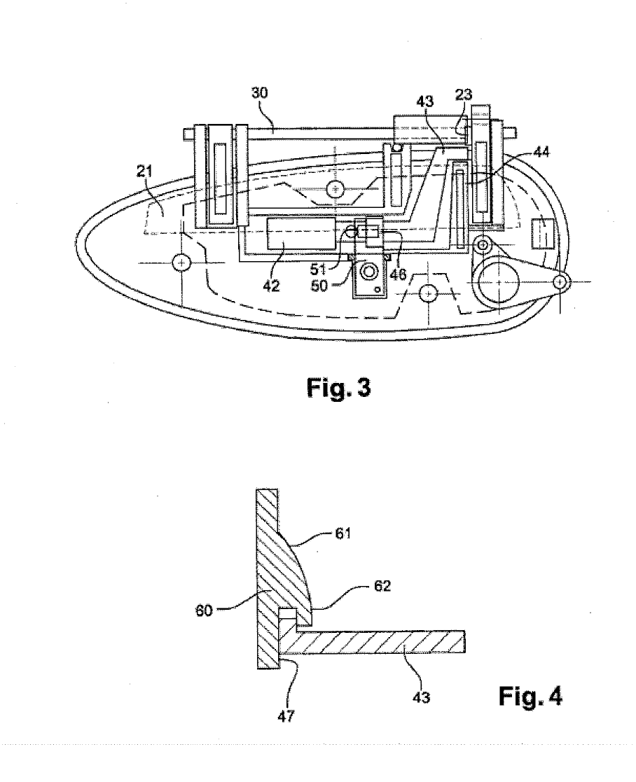

FIG. 3 is a view from behind of a handle according to a second embodiment;

FIG. 4 shows a retaining member according to one embodiment of the invention;

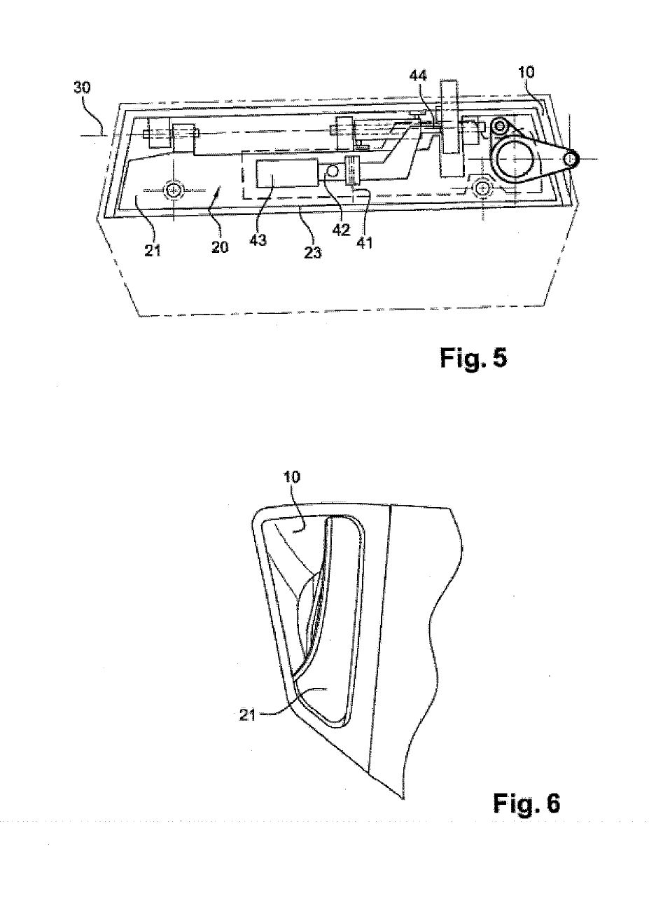

FIG. 5 is a view from behind of a handle according to a third embodiment of the invention;

FIG. 6 is a front view of a handle according to a fourth embodiment of the invention;

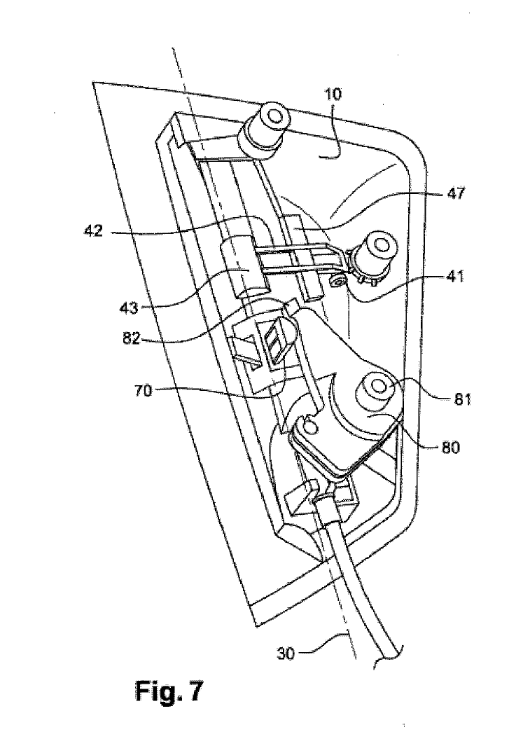

FIG. 7 is a view from behind of a handle according to this same fourth embodiment of the invention.

With reference to FIG. 1, it can be seen that the handle according to the first embodiment of the invention comprises, as in the prior art, a fixed frame 10 and a lever plate 20 mounted so as to pivot on this frame about a spindle 30.

The movable portion or lever plate 20 has a gripping lever plate 21 consisting of a blank of plastic that is substantially flat and exposed to manual contact. The lever plate is returned to its rest position against the fixed portion by a spring 4 of the helical type wound around the spindle 3.

FIG. 2 shows that the lever-plate handle 2 is extended by an arm 22 made in one piece with it or fitted securely toward the inside of the vehicle door. The arm 22 therefore pivots about the spindle 3 with the rest of the lever plate and describes a movement downward inside the door.

Fixed to the end of this arm 22 is the end of a cable the operation of which actuates a lock that is not shown.

The handle according to this embodiment also has an inertial pendulum 40 mounted on the fixed portion about a vertical spindle 41 and consisting mainly of two opposite arms 42 and 44 situated on either side of the spindle 41. The arm 42 is heavier than the arm 44 so that an impact on the handle causes a rocking of the rocker 40 dictated by the inertia of the arm 42.

The arm 42 is situated, in a plane parallel to the main plane of the handle, substantially in line with the center of gravity of the gripping lever plate 21.

More particularly, the arm 42 has an excrescence 43 forming an inertial mass that is situated at a degree of advancement along the handle that situates it in a central third of the zone of extent of the lever plate.

Thus positioned, it is found that the inertial mass reproduces the same dynamic behavior as the lever plate in the event of impact. Taking account of the fact that a side impact on the vehicle results in an acceleration that is vibratory and has an orientation along the three axes of the space, this acceleration being variable in orientation during the vibrations, it is found to be necessary to the reliability of the handle that the inertial mass correctly reproduces the displacement movement of the lever plate in the event of impact in order to anticipate the latter.

It is found that by positioning the inertial mass in the foremost longitudinal two thirds of the lever plate relative to the direction of the vehicle, the inertial mass also being positioned so as to be equally in line, at least partly, with the gripping portion of the lever plate, a combination of respectively longitudinal and transverse positionings is obtained that produces a result that is especially effective in terms of reliability on impacts of the inertial mass.

Within this particularly advantageous range in longitudinal and transverse positioning, a positioning of the inertial mass that is slightly offset forward further increases the reliability on impact of the inertial mass, because the inertial mass then moreover has sensitivity to the deformation of the metal sheet of the door, typically in front of the handle, which causes an additional acceleration to occur on the handle and provides an additional layer of reliability.

Also, an inertial mass situated in the front half of the central third of the length of the lever plate is particularly reliable.

Nevertheless, a positioning of the inertial mass close to the center of gravity of the gripping lever plate gives reliability to the inertial mass and advantageously closeness of the inertial mass to the longitudinal center of the lever plate is retained.

In terms of degree of positioning of the inertial mass in a direction that is transverse to the lever plate, it is indeed advantageous to position the inertial mass facing an off-center half of the gripping lever plate, that is to say in the half furthest from the rotation spindle of the lever plate. Preferably, the inertial mass is in line with the free edge of the lever plate, i.e. in line with the edge 23 of the lever plate that is at a distance from the rotation spindle and that is intended to come into the hollow of the hand of the user.

It is in line with this edge that the inertial mass best reproduces the rocking of the lever plate.

The arm 44, for its part, extends along three successive sections until it is laterally flush with the extension arm 22 of the lever plate 20. Specifically, this shape allows it to move away laterally from a main longitudinal axis of the rocker 40, from a substantially central zone of the lever plate to a laterally offset zone, i.e. at the extension arm 22 of the lever plate.

The arm 44 therefore forms an abutment part which is inserted into the path of a movable part of the handle, in this instance namely the arm 22. The end of the arm 44 is inserted into the path of a portion of the arm 22 and more particularly into the path of a lateral appendage 25 of the arm 22.

Thus, and as shown in FIG. 2, the end of the arm 44 has two possible positions, one retracted and the other advanced toward the inside of the door, the latter position corresponding to a positioning of the end of the arm 44 just beneath the appendage 25, on its downward path.

The pendulum 40 is returned to its retracted rest position by a compression or bending spring 45.

The blocking pendulum thus rocks about a spindle 41 that is substantially perpendicular to the rotation spindle of the lever plate 20, which is particularly efficient in terms of reliability on impact, and allows the use of a pendulum having an inertial mass 40 substantially in line with the central third of the gripping lever plate and a locking arm reaching a lateral zone where it can effectively lock an extension arm of the lever plate 20.

More particularly, the arm 42 has an excrescence 43 forming an inertial mass that is situated at a degree of advancement along the handle that situates it in a central third of the zone of extent of the lever plate.

Here again, thus positioned, it is found that the inertial mass reproduces the same dynamic behavior as the lever plate in the event of impact. Taking account of the fact that a side impact on the vehicle results in an acceleration that is vibratory and has an orientation along the three axes of the space, this acceleration being variable in orientation during the vibrations, it is found to be necessary to the reliability of the handle that the inertial mass correctly reproduces the displacement movement of the lever plate in the event of impact in order to anticipate the latter.

It is found that by positioning the inertial mass in the foremost longitudinal two thirds of the lever plate relative to the direction of the vehicle, the inertial mass also being positioned so as to be equally in line, at least partly, with the gripping portion of the lever plate, a combination of respectively longitudinal and transverse positionings is obtained that produces a result that is especially effective in terms of reliability on impacts of the inertial mass.

Within this particularly advantageous range in longitudinal and transverse positioning, a positioning of the inertial mass that is slightly offset forward further increases the reliability on impact of the inertial mass, because the inertial mass then moreover has sensitivity to the deformation of the metal sheet of the door, typically in front of the handle, which causes an additional acceleration to occur on the handle and provides an additional layer of reliability.

Also, an inertial mass situated in the front half of the central third of the length of the lever plate is particularly reliable.

Nevertheless, a positioning of the inertial mass close to the center of gravity of the gripping lever plate gives reliability to the inertial mass and advantageously closeness of the inertial mass to the longitudinal center of the lever plate is retained.

In terms of degree of positioning of the inertial mass in a direction that is transverse to the lever plate, it is indeed advantageous to position the inertial mass facing an off-center half of the gripping lever plate, that is to say in the half furthest from the rotation spindle of the lever plate. Preferably, the inertial mass is in line with the free edge of the lever plate, i.e. in line with the edge 23 of the lever plate that is at a distance from the rotation spindle and that is intended to come into the hollow of the hand of the user.

It is in line with this edge that the inertial mass best reproduces the rocking of the lever plate.

In order to further strengthen the locking of the lever plate, a firm stop element 45 is provided under the end of the arm 44 so that the end of the arm 44 is sandwiched between the arm 22 and the firm stop element 46 during a side impact. The arm 44 then sustains no vertical stress which would tend to damage its behavior at its articulation about the spindle 44. The firm stop element 46 is preferably secured to the fixed portion 10 of the handle.

According to an embodiment shown in FIG. 3, a member for retaining the rocker 40 in its locking position is also adopted in the form notably of a metal strip 50 of which one face receives a lug 46 of the rocker in friction and furnished with an orifice 51 which receives this lug after rocking of the rocker 40.

This member makes it possible to prevent a rebound of the rocker at the end of travel, which rebound could return it to its initial position and then cause it to be absent during the immediately subsequent closing in of the extension arm of the lever plate during the impact.

With reference to FIG. 4, the metal strip 50 may be replaced by a coupling member 60 having a slope 61 and a lug 62 so that the end of the branch 47 of the rocker slides against the slope 61, is placed behind the lug 62 and thus remains in position of insertion into the path of the lever plate 20.

Such a coupling member advantageously slides in a direction transverse to the main direction of extension of the arm 44, to a position in which the coupling member is retracted relative to this end and no longer retains the arm 44.

Thus, by a manual actuation of the coupling member 60, the arm 44 is released without damaging the various portions that are present and without the need for particular inspection of the integrity of the various components.

The fixed portion 1 of the handle may be placed inside or outside the door, i.e. being visible or hidden from the outside.

In the case of a fixed portion 1 mounted inside the door, and when the available volume is restricted, it is preferred to avoid an anti-rebound device like one of those described above, especially since certain gripping lever plates are lightweight and therefore do not require such a system because of their dynamic behavior.

Such a handle is shown in FIG. 5. This handle has a substantially elongate gripping lever plate and the inertial mass 43 of the rocker 40 is here again substantially in line with the central third of the gripping lever plate 21. More particularly, the arm 42 has an excrescence 43 forming an inertial mass that is situated at a degree of advancement along the handle that situates it in a central third of the zone of extent of the lever plate.

Thus positioned, it is found that the inertial mass reproduces the same dynamic behavior as the lever plate in the event of impact. Taking account of the fact that a side impact on the vehicle results in an acceleration that is vibratory and has an orientation along the three axes of the space, this acceleration being variable in orientation during the vibrations, it is found to be necessary to the reliability of the handle that the inertial mass correctly reproduces the displacement movement of the lever plate in the event of impact in order to anticipate the latter.

It is found that by positioning the inertial mass in the foremost longitudinal two thirds of the lever plate relative to the direction of the vehicle, the inertial mass also being positioned so as to be equally in line, at least partly, with the gripping portion of the lever plate, a combination of respectively longitudinal and transverse positionings is obtained that produces a result that is especially effective in terms of reliability on impacts of the inertial mass.

Within this particularly advantageous range in longitudinal and transverse positioning, a positioning of the inertial mass that is slightly offset forward further increases the reliability on impact of the inertial mass, because the inertial mass then moreover has sensitivity to the deformation of the metal sheet of the door, typically in front of the handle, which causes an additional acceleration to occur on the handle and provides an additional layer of reliability.

Also, an inertial mass situated in the front half of the central third of the length of the lever plate is particularly reliable.

Nevertheless, a positioning of the inertial mass close to the center of gravity of the gripping lever plate gives reliability to the inertial mass and advantageously closeness of the inertial mass to the longitudinal center of the lever plate is retained.

In terms of degree of positioning of the inertial mass in a direction transverse to the lever plate, in this instance the inertial mass is positioned in a middle portion of the width of the lever plate, that is to say between its rotation spindle 30 and the edge 23 which is intended to come into the hollow of the hand of the user, i.e. the edge that is distant from the rotation spindle 30 of the lever plate.

As shown in FIGS. 6 and 7, a handle according to the invention is placed as a variant in a door upright, then extending substantially vertically to the vehicle.

The handle is advantageously articulated about a rotation spindle parallel to the door upright and actuates a cable running along the door upright.

The handle is placed obliquely relative to the vertical of the vehicle so that the handle here again has one longitudinal portion placed substantially toward the front and one longitudinal portion placed substantially toward the rear, of which it is advantageous to take account in the positioning of the inertial mass.

To actuate this cable, the lever plate of this handle extends in the form of a lever plate lever 70 which in turn actuates an operating lever 80 mounted rotatably about a spindle 81 that is transverse to the main plane of the fixed portion 10 of the handle.

In this embodiment, a rocker 40 with inertial mass 43 is itself placed so that this inertial mass faces the longitudinal center of the gripping lever plate 21 of the handle, that is to say substantially facing the geometric center of the panel exposed to the outside of the handle that can be seized by a user in order to open the door. The inertial mass 43 also has an advancement that is transverse to the handle such that the inertial mass is at least partially in line with a portion of the gripping lever plate, in this instance a portion close to the rotation spindle of the lever plate.

The rocker 40, in this embodiment, takes the form of a branch 42 extending from a rotation spindle 41 and supporting the inertial mass 43 at its end. The rotation spindle 41 is in this instance parallel to the rotation spindle 30 of the lever plate 20. The arm 42 also has, in the mid-portion between the spindle 41 and the inertial mass 43, a fin 47 extending transversely to the arm 42, that is to say parallel to the spindle 41, and forming an abutment part in order to be placed in the path of a movable part of the handle, namely in this instance the operating lever 80 and more particularly the end 82 of the operating lever 80 when the arm 42 is moved under the effect of the inertia of an impact.

Thus positioned, it is found that the inertial mass reproduces the same dynamic behavior as the lever plate in the event of impact. Taking account of the fact that a side impact on the vehicle results in an acceleration that is vibratory and has an orientation along the three axes of the space, this acceleration being variable in orientation during the vibrations, it is found to be necessary to the reliability of the handle that the inertial mass correctly reproduces the displacement movement of the lever plate in the event of impact in order to anticipate the latter.

More generally, it is found that by positioning the inertial mass in the foremost longitudinal two thirds of the lever plate relative to the direction of the vehicle, the inertial mass also being positioned so as to be equally in line, at least partly, with the gripping portion of the lever plate, a combination of respectively longitudinal and transverse positionings is obtained that produces a result that is especially effective in terms of reliability on impacts of the inertial mass.

Within this particularly advantageous range in longitudinal and transverse positioning, a positioning of the inertial mass that is slightly offset forward further increases the reliability on impact of the inertial mass, because the inertial mass then moreover has sensitivity to the deformation of the metal sheet of the door, typically in front of the handle, which causes an additional acceleration to occur on the handle and provides an additional layer of reliability.

Also, an inertial mass situated in the front half of the central third of the length of the lever plate is particularly reliable.

Nevertheless, a positioning of the inertial mass close to the center of gravity of the gripping lever plate gives reliability to the inertial mass and advantageously closeness of the inertial mass to the longitudinal center of the lever plate is retained.

The fin 47 advantageously extends on either side of the arm 42 in order to make such a rocker adaptable without distinction to a right handle or to a left handle.

1. A motor vehicle door handle comprising:
a gripping element configured to rotate about a spindle on a fixed portion fixed to the door and connected to a lock of the motor vehicle; and
an abutment part forming part of a rocker, the abutment part comprising an inertial mass and is articulated on the fixed portion so as to pivot about the spindle,
wherein when there is a violent pivoting of the rocker, the abutment part moves on a path of a movable part of the handle and prevents actuation of the lock connected to the handle,
wherein the gripping element is a gripping lever plate and the inertial mass is placed on the handle at a longitudinal advancement of the latter situated in a front two thirds of a length of the gripping lever plate relative to a frame of reference of the motor vehicle, and at a transverse advancement to the handle such that the inertial mass is at least partially in line with the gripping lever plate, so that the inertial mass sustains the same forces of inertia as the gripping element.

2. The handle as claimed in claim 1, wherein the inertial mass is situated at a transverse degree of positioning to the gripping lever plate so that the inertial mass is in line with a lower limit of the gripping lever plate.

3. The handle as claimed in claim 1, wherein the inertial mass is at a degree of longitudinal advancement of the handle situated toward the front of the vehicle relative to a longitudinal center of the gripping lever plate.

4. The handle as claimed in claim 1, wherein the rocker has a rotation spindle situated at a degree of longitudinal advancement of the handle that is toward the rear of the vehicle relative to the inertial mass.

5. The handle as claimed in claim 1, wherein the gripping lever plate has a rotation spindle that is parallel to the rotation spindle of the rocker.

6. The handle as claimed in claim 1, wherein the rocker and the lever plate have respective rotation spindles which are substantially perpendicular to one another.

7. The handle as claimed in claim 1, wherein the rocker has two arms situated on either side of the rotation spindle of the rocker, one of the two arms supporting the inertial mass and another of the two arms forming the abutment part.

8. The handle as claimed in claim 7, wherein the arm forming the abutment comprises three successive sections of which one intermediate section is oblique relative to the other two sections, so that said other two sections have substantially one and the same orientation but have a lateral offset relative to one another.

9. The handle as claimed in claim 8, wherein an orientation of said other sections of the arm forming the abutment is substantially the same as an orientation of the rotation spindle of the gripping lever plate.

10. The handle as claimed in claim 1, further comprising an element for retaining the rocker, configured to hold the rocker in displaced position following an impact on the door of the vehicle.
